(19) United States
(12) Patent Application Publication
(10) Pub. No.: US 2018/0058316 A1
(43) Pub. Date: Mar. 1, 2018

(54) VAPOR PLANT AND METHOD OF OPERATING A VAPOR PLANT

(71) Applicant: Dürr Systems AG, Bietigheim-Bissingen (DE)

(72) Inventors: Martin Schroeter, Ann Arbor, MI (US); Erhard Rieder, Herrenberg (DE)

(21) Appl. No.: 15/686,443

(22) Filed: Aug. 25, 2017

(30) Foreign Application Priority Data
Aug. 31, 2016 (DE) 10 2016 216 437.6

(51) Int. Cl. F02C 3/30; F02C 3/04; F02C 3/34; F01K 23/10; F02C 7/141; F01N 3/10; F01K 11/02; B01D 53/86

(52) U.S. Cl. CPC F02C 3/30; F02C 3/04; F02C 3/34; F01K 23/10; F02C 7/141; F01D 15/10; F01K 11/02; B01D 53/864; F05D 2220/32; F05D 2260/212; F05D 2240/35; F01N 3/10

(57) ABSTRACT

In order to provide a vapor plant which is operable in an energy-efficient manner, has as high a degree of efficiency as possible and/or enables nitrogen oxide to be reduced without additives, the vapor plant includes the following: a gas turbine device which comprises a compressor, a combustion chamber and a turbine; a vapor device for the production of vapor and for the supply of vapor to the combustion chamber; an exhaust gas system for the removal of the exhaust gas produced in the combustion chamber; a heat exchanger by means of which the exhaust gas system on the one hand and the vapor device on the other are thermally coupled or couplable to one another; a condensing device by means of which the exhaust gas system on the one hand and the vapor device on the other are thermally coupled or couplable to one another.

### RELATED APPLICATION

This application claims the benefit of German application No. 10 2016 216 437.6 filed on Aug. 31, 2016, which is incorporated herein by reference in its entirety and for all purposes.

### FIELD OF DISCLOSURE

The present invention relates to a vapor plant such as a power station for example and in particular a gas and steam turbine power station.

### SUMMARY OF THE INVENTION

The object of the present invention is to provide a vapor plant which is operable in an energy-efficient manner and has as high a degree of efficiency as possible and/or which enables a reduction of nitrogen oxide without additives.

In accordance with the invention, this object is achieved by a vapor plant in accordance with Claim 1.

The vapor plant according to the invention preferably comprises a gas turbine device which comprises a compressor, a combustion chamber and a turbine.

Furthermore, the vapor plant preferably comprises a vapor device for producing vapor and for supplying at least a portion of the vapor to the combustion chamber.

In addition, provision may be made for the vapor plant to comprise an exhaust gas system for the removal of exhaust gas produced in the combustion chamber.

Preferably, the vapor plant additionally comprises a heat exchanger by means of which the exhaust gas system on the one hand and the vapor device on the other are thermally coupled or couplable to one another.

It can be expedient if the vapor plant comprises a condensing device by means of which the exhaust gas system on the one hand and the vapor device on the other are thermally coupled or couplable to one another.

In particular, the condensing device is a different device from the heat exchanger, for example, a spatially and/or functionally separate device.

The vapor plant according to the invention is preferably a power station.

The power station is in particular a gas and steam turbine power station.

In particular, vapor is steam.

Due to the fact that the vapor plant according to the invention preferably comprises a combination of a heat exchanger and a condensing device, then, on the one hand, a large amount of heat can be transferred very efficiently from the exhaust gas to the fluid being fed through the vapor device, in particular, a liquid or vapor. On the other hand thereby, vapor contained in the exhaust gas can preferably be condensed in order to recover the enthalpy of vaporization of the vapor contained in the exhaust gas. The vapor plant as a whole can preferably thereby be operated in a particularly energy-efficient manner as well as with a high degree of efficiency.

It can be expedient if the vapor device comprises a liquid supply system.

The exhaust gas system on the one hand and the liquid supply system on the other are preferably thermally coupled or couplable to one another by means of the condensing device.

In particular, provision may be made for the liquid supply system to be thermally coupled to the vapor device through the condensing device or to be conducted along and thermally coupled thereto and in particular to extend up to the heat exchanger by means of which the exhaust gas system on the one hand and the vapor device on the other hand are thermally coupled or couplable to one another.

This heat exchanger thereby serves in particular for heating the liquid being fed through the liquid supply system to such an extent that this liquid evaporates and/or the vapor produced thereby is superheated.

It follows therefore that the heat exchanger by means of which the exhaust gas system on the one hand and the vapor device on the other are thermally coupled or couplable to one another is, in particular, a transition region between a liquid supply system of the vapor device on the one hand and a vapor supply system of the vapor device on the other.

In particular, the heat exchanger is a so-called waste heat recovery boiler or Heat Recovery Steam Generator (HRSG).

Preferably the condensing device comprises a reservoir container for accommodating and/or storing condensate of the exhaust gas.

The condensate of the exhaust gas is, in particular, a condensate from the condensing device.

It can be advantageous if the condensing device comprises a feedback device by means of which the condensate of the exhaust gas is suppliable as a liquid to a liquid supply system of the vapor device.

Taken with respect to a direction of flow of the exhaust gas in the exhaust gas system, the condensing device is preferably arranged downstream of the heat exchanger by means of which the exhaust gas system on the one hand and the vapor device on the other are thermally coupled or couplable to one another.

It can be advantageous if the vapor plant comprises one or more catalytic devices for purifying the exhaust gas.

Taken with respect to a direction of flow of the exhaust gas in the exhaust gas system, a catalytic device is, for example, arranged upstream of the heat exchanger by means of which the exhaust gas system on the one hand and the vapor device on the other are thermally coupled or couplable to one another.

As an alternative or in addition thereto, provision may be made for a catalytic device to be arranged between the condensing device and the heat exchanger taken with respect to a direction of flow of the exhaust gas in the exhaust gas system, the exhaust gas system on the one hand and the vapor device on the other being thermally coupled or couplable to one another by means of said heat exchanger.

In addition, provision may be made for the vapor plant to comprise two or more catalytic devices, wherein a respective catalytic device is preferably arranged in one of the previously described positions.

Preferably, substances contained in the exhaust gas and in particular impurities are chemically convertible exothermically by means of the one or the plurality of catalytic devices. The heat being released thereby is preferably used for heating up the stream of exhaust gas. In particular, the heat which is released by the exothermic chemical conversion of the substances contained in the exhaust gas is absorbed by the exhaust gas stream and/or is carried along therewith. This can be referred to as a catalytically induced exhaust gas heating process for example.

The exhaust gas stream is thereby preferably heated in such a manner that any thermal disadvantage which results in particular from the process of supplying vapor to the combustion chamber is partly compensated or is at least approximately entirely compensated.

For example, provision may be made for any thermal disadvantage resulting from the process of supplying vapor to the combustion chamber to be partly compensated or to be at least approximately entirely compensated by the combination of the catalytically induced exhaust gas heating process on the one hand and the condensation of constituents of the exhaust gas on the other.

In one embodiment of the invention, provision may be made for the vapor plant to comprise a recuperating device by means of which heat contained in the exhaust gas is at least partially transferable to at least a part of a flow of gas which is to be supplied to the combustion chamber.

In particular, the gas flow is an air-supply stream.

In particular, the gas flow and in particular the air-supply stream is suppliable by means of an air supply system of the gas turbine device to a compressor and afterwards to a combustion chamber of the gas turbine device.

The recuperating device comprises, in particular, a heat exchanger by means of which the air supply system and the exhaust gas system are thermally coupled or couplable to one another.

In particular thereby, taken with respect to a direction of flow of the air-supply stream, the heat exchanger is arranged downstream of the compressor and/or upstream of the combustion chamber.

Furthermore, taken with respect to the direction of flow of the exhaust gas, provision may be made for the heat exchanger of the recuperating device to be arranged downstream of the turbine and/or upstream of a catalytic device and/or of a heat exchanger by means of which the exhaust gas system on the one hand and the vapor device on the other are thermally coupled or couplable to one another.

Furthermore the present invention relates to a method of operating a vapor plant such as a power station for example and in particular a gas and steam turbine power station.

In this regard, the object of the invention is to provide a method by means of which a vapor plant is operable energy-efficiently and with as high a degree of efficiency as possible.

The method is suitable in particular for operating a vapor plant according to the invention.

In accordance with the invention, this object is achieved by the independent method Claim.

The method according to the invention preferably comprises individual ones or a plurality or all of the following processing steps:

conversion of fuel and oxidizer in a combustion chamber of a gas turbine device of the vapor plant;

supplying vapor to the combustion chamber;

removing the exhaust gas produced in the combustion chamber from the combustion chamber;

transferring heat from the exhaust gas to a vapor device for the purposes of producing vapor by means of a heat exchanger;

condensing at least a portion of the vapor contained in the exhaust gas by means of a condensing device.

In particular, in the case of the method in accordance with the invention, no provision is made for a process of injecting ammonia and/or urea or any other form of supplying an exhaust gas purifying agent and advantageously as a rule—at least in the case of the currently prevailing and expected restrictions on emissions—this is also not necessary.

Due to the process of supplying vapor to the combustion chamber, the temperature in the combustion chamber is preferably lowered to a sufficient extent as to reduce or, at least for the most part, to prevent the production of nitrogen oxides.

In one embodiment of the invention, provision may be made after the transferal of heat from the exhaust gas to the vapor device for the temperature of the exhaust gas directly downstream of the heat exchanger to lie above the dew point of water, in particular, at the pressure conditions prevailing within this region of the exhaust gas system.

Furthermore, provision may be made for the temperature of the exhaust gas to be lowered below the dew point of water by means of the condensing device, in particular, at the pressure levels prevailing within this region of the exhaust gas system.

It can be advantageous if the temperature of the exhaust gas upstream of the condensing device lies above the dew point of water taken with respect to a direction of flow of the exhaust gas.

With respect to the direction of flow of the exhaust gas, the temperature of the exhaust gas downstream of the condensing device and in particular directly downstream of the condensing device preferably lies below the dew point of water.

Thus, the temperature of the exhaust gas is preferably reduced in two steps in order to reutilize the heat contained in the exhaust gas as efficiently as possible: in a first step, heat is preferably transferred from the exhaust gas to the vapor device by means of the heat exchanger in order to evaporate and/or superheat the fluid and in particular the liquid and/or vapor that is being fed into the vapor device. In a next step, the temperature of the exhaust gas is preferably lowered below the dew point of water by means of the condensing device in order to at least partly condense the vaporous water contained in the exhaust gas and thereby make the enthalpy of vaporization usable. In particular thereby, the liquid and in particular water being fed to the vapor device in a liquid supply system can be preheated.

Impurities contained in the exhaust gas are preferably chemically converted by means of a catalytic device. In particular, an exothermic reaction of the impurities contained in the exhaust gas can thereby be obtained, whereby the exhaust gas within the exhaust gas system can be heated up.

In particular, taken with respect to the direction of flow of the exhaust gas, the exhaust gas is heated by means of the catalytic device between the heat exchanger, by means of which the exhaust gas system on the one hand and the vapor device on the other are thermally coupled or couplable to one another, and the condensing device.

At least a part of the condensate of the exhaust gas produced by means of the condensing device is preferably re-vaporized and supplied to the combustion chamber.

To this end, the condensate is supplied in particular to the liquid supply system of the vapor device and then firstly heated in the condensing device and thereafter vaporized and/or superheated by means of the heat exchanger.

The supply of vapor to the combustion chamber is preferably controlled and/or regulated in such a manner that the proportion of water in the exhaust gas amounts to at least approximately 6 Vol %, preferably to at least approximately 8 Vol %, for example, to at least approximately 10 Vol %.

In particular hereby, the aforesaid proportions of water are related to the composition of the exhaust gas directly downstream of the combustion chamber and/or the turbine and/or the heat exchanger by means of which the exhaust gas system on the one hand and the vapor device on the other are thermally coupled or couplable to one another.

It can be expedient if the vapor produced in the vapor plant by means of the vapor device is partly supplied to the combustion chamber and partly to a vapor turbine of the vapor plant.

Furthermore, provision could also be made for some other usage for the surplus of vapor from the vapor produced by means of the vapor device but which is not supplied to the combustion chamber.

The humidity of the exhaust gas is preferably increased by supplying vapor to the combustion chamber in such a manner that values are reached which are typical for a stoichiometric combustion process in the combustion chamber. Nevertheless, a combustion process with excess air is preferably provided.

The amount of fuel required and accordingly the amount of carbon dioxide emitted can preferably be reduced by virtue of the construction provided by the invention.

An increase in the production of carbon monoxide which could result from the reduced temperatures in the combustion chamber due to the supply of vapor is preferably compensated by the use of a catalytic device.

Preferably, a distribution between the attainable amount of thermal energy and the attainable amount of electrical energy can be deliberately varied by appropriately controlling and/or regulating the vapor plant.

The invention is in principle suitable for all types of vapor units, power stations and/or gas turbines in which in particular there is provided a reduction in the amount of nitrogen oxide in the exhaust gas system in ammonia-free manner.

The vapor plant preferably comprises a generator for the production of electrical energy.

In particular, the generator is mechanically coupled to the gas turbine device and in particular to a shaft of the gas turbine device and makes it possible to convert mechanical energy into electrical energy.

Further preferred features and/or advantages of the invention form the subject matter of the following description and the graphical illustration of exemplary embodiments.

### BRIEF DESCRIPTION OF THE DRAWINGS

FIG. 1 shows a schematic illustration of a vapor plant in which provision is made for the recovery of the heat of the exhaust gas by the use of a heat exchanger and a condensing device, wherein a catalytic device is arranged between the heat exchanger and the condensing device;

FIG. 2 a schematic illustration corresponding to FIG. 1 of a second embodiment of a vapor plant in which the catalytic device is arranged upstream of the heat exchanger taken with respect to the direction of flow of the exhaust gas; and

FIG. 3 a schematic illustration corresponding to FIG. 1 of a third embodiment of a vapor plant in which an additional recuperating device is provided.

Similar or functionally equivalent elements are provided with the same reference symbols in all of the Figures.

### DETAILED DESCRIPTION OF THE DRAWINGS

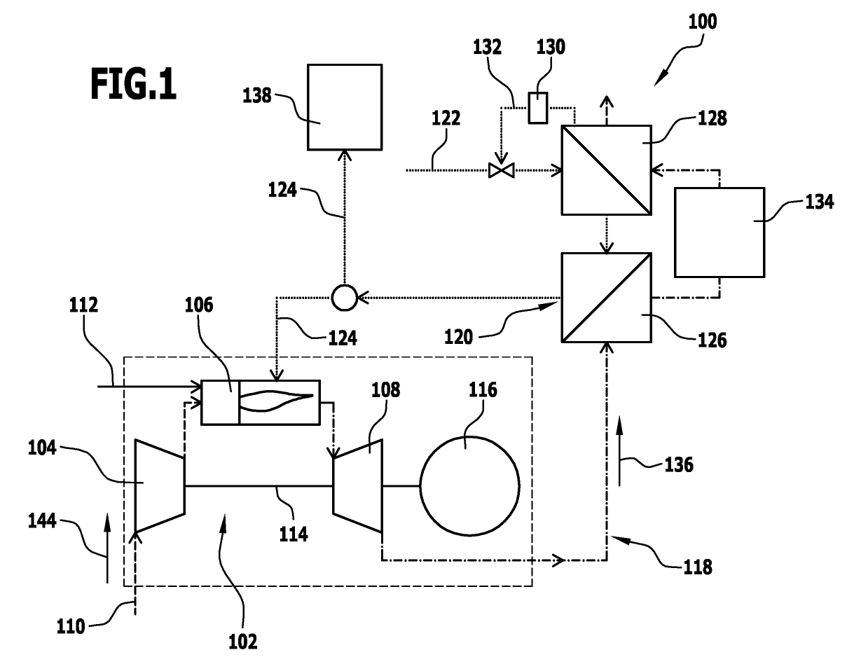

A first embodiment of a vapor plant which is illustrated in FIG. 1 and designated therein as a whole by 100 is, for example, a power station and in particular a gas and steam turbine power station for the production of heat and/or electrical energy.

The vapor plant 100 comprises in particular a gas turbine device 102.

The gas turbine device 102 comprises a compressor 104, a combustion chamber 106 and a turbine 108.

An air supply inlet 110 of the gas turbine device 102 serves for the supply of air to the combustion chamber 106.

A fuel supply inlet 112 of the gas turbine device 102 serves for the supply of fuel to the combustion chamber 106.

The air being supplied by way of the air supply inlet 110 is compressible by means of the compressor 104 in order to eventually enable air at increased pressure to be supplied to the combustion chamber 106.

For this purpose, the compressor 104 is driven by the turbine 108 via a shaft 114 of the gas turbine device 102.

Furthermore, the shaft 114 preferably couples the turbine 108 and/or the compressor 104 to a generator 116 of the vapor plant 100. The generator 116 serves for the transformation of mechanical energy into electrical energy.

However, as an alternative to or in addition to the shaft 114, other means of coupling the compressor 104, the turbine 108 and/or the generator 116 could also be provided.

The turbine 108 is arranged in an exhaust gas system 118 of the vapor plant 100 whereby the exhaust gas from the combustion chamber 106 that is being fed into the exhaust gas system 118 is able to flow therethrough in order to eventually cause rotation of the turbine 108, the compressor 104, the shaft 114 and parts of the generator 116.

Furthermore, the vapor plant 100 comprises a vapor device 120 for the production of vapor and in particular water vapor.

The vapor device 120 comprises a liquid supply system 122 for the supply of liquid, in particular, water.

Furthermore, the vapor device 120 comprises a vapor supply system 124 in which the liquid that is initially being fed through the liquid supply system 122 and is subsequently vaporized is conveyable in the vaporous state.

The vapor plant 100 preferably comprises a heat exchanger 126 by means of which the exhaust gas system 118 and the vapor device 120 are thermally coupled or couplable to one another.

Thus in particular, the heat from the exhaust gas of the combustion chamber 106 is transferable to the fluid being fed through the vapor device 120 and in particular the liquid being fed through the liquid supply system 120 and/or the vapor being fed through the vapor supply system 124 by means of the heat exchanger 126.

Furthermore, the vapor plant 100 comprises a condensing device 128 by means of which the exhaust gas system 118 and the liquid supply system 122 of the vapor device 120 are thermally coupled or couplable to one another.

In particular, the vapor contained in the exhaust gas can be condensed by means of the condensing device 128 in order to utilize the enthalpy of vaporization available therein for heating the liquid being fed through the liquid supply system 122.

The condensate obtained in the condensing device 128 can be stored in particular by means of a reservoir container 130 of the vapor plant 100 and/or be supplied to the liquid supply system 122 of the vapor device 120 by means of a feedback device 132 of the vapor plant 100.

Furthermore, the vapor plant 100 preferably comprises a catalytic device 134.

The catalytic device 134 is preferably arranged in the exhaust gas system 118 and exhaust gas is passable therethrough.

In particular, purification of the exhaust gas is effectible by means of the catalytic device 134. For example, catalytic oxidation of carbon mono-oxide is feasible by means of the catalytic device 134. As an alternative or in addition thereto, provision may be made for further or other constituents and in particular impurities in the exhaust gas to be chemically convertible by means of the catalytic device 134. The chemical conversion of constituents of the exhaust gas preferably takes place exothermically so that, in particular, heat is released and used for heating the exhaust gas.

The catalytic device 134 is preferably arranged between the heat exchanger 126 and the condensing device 128 taken with respect to a direction of flow 136 of the exhaust gas in the exhaust gas system 118.

The vapor produced by means of the vapor device 120 can be supplied, in particular, via the vapor supply system 124 to the combustion chamber 106 in order to increase the moisture content of the exhaust gas in and/or from the combustion chamber 106.

Furthermore for example, the vapor obtainable by means of the vapor device 120 can be supplied to a vapor turbine 138 of the vapor plant 100 in order to eventually run the generator 116 or a (not illustrated) further generator.

As an alternative or in addition thereto, provision can also be made for some other use of the vapor. For example, the vapor can be used in and/or for a district heating network, one or more industrial manufacturing processes and/or one or more purification processes.

The first embodiment of the vapor plant 100 illustrated in FIG. 1 functions as follows:

Air for example is sucked in from the surroundings of the gas turbine device 102 by means of the air supply inlet 110, then compressed by means of the compressor 104 and supplied to the combustion chamber 106.

Fuel is supplied to the combustion chamber 106 by means of the fuel supply inlet 112.

In addition, vapor is supplied to the combustion chamber 106 by means of the vapor supply system 124.

The fuel is chemically converted exothermically in the combustion chamber 106 by the oxygen contained in the air. Hereby, apart from carbon dioxide and water, unwanted pollutants such as nitrogen oxides (NOₓ) for example can also be produced. The temperatures occurring in the combustion chamber 106 can preferably be reduced by the supply of vapor to the combustion chamber 106, something which can eventually result, in particular, in a reduced production of nitrogen oxide.

The supply of vapor thus preferably enables the gas turbine device 102 to operate in a particularly nitrogen-oxide-lean manner.

The energy that is released in the combustion chamber 106 is partly converted into mechanical energy by means of the turbine 108 in order to drive the shaft 114 and eventually the compressor 104 as well as parts of the generator 116. The supply of vapor thereby preferably leads to an increase in the mechanical performance of the turbine 108 (compared with operating the gas turbine device 102 without a supply of vapor).

The exhaust gas being fed into the exhaust gas system 118 downstream of the turbine 108 still contains large amounts of heat which should be re-used for an energy-efficient operation of the vapor plant 100.

Preferably thereby, the major part of the heat contained in the exhaust gas is transferred to the fluid being fed through the vapor device 120 by means of the heat exchanger 126.

Downstream of the heat exchanger 126, the exhaust gas is then fed through the catalytic device 134 and thereby purified by virtue of the exothermic reactions taking place therein as well as being at least slightly reheated.

The exhaust gas is then cooled down further by means of the condensing device 128 in that the heat contained therein is transferred to the liquid being fed through the liquid supply system 122. In particular, the exhaust gas is cooled down in the condensing device 128 to such an extent that the vaporous constituents contained therein, in particular water vapor, condense out. This thereby results in a yet more efficient use of the heat contained in the exhaust gas.

The exhaust gas is then preferably released to the surroundings of the vapor plant 100 downstream of the condensing device 128.

The condensate produced in the condensing device 128 is, for example, supplied to a reservoir container 130 for the purposes of storage thereof and/or supplied by way of a feedback device 132 to the liquid supply system 122 of the vapor device 120.

The condensate can thus be supplied, in particular, together with the liquid being supplied via the liquid supply system 122, in particular water, for renewed usage in the vapor device 120.

The liquid being fed through the liquid supply system 122 is firstly supplied to the condensing device 128 and heated up and in particular preheated therein by absorption of heat from the exhaust gas. Thereby, the liquid preferably still remains in the liquid state.

Further heating of the liquid which leads in particular to evaporation and/or superheating preferably takes place in the heat exchanger 126.

In particular, superheated vapor is produced by means of the heat exchanger 126.

The vapor is then supplied in part to the combustion chamber 106 by way of the vapor supply system 124 and is partly used in other ways. For example, vapor is partly supplied to the vapor turbine 138 for the purposes of electrical energy and/or is partly passed on for other possibilities of use.

Due to the fact that the vapor plant 100 comprises a combination of a heat exchanger 126 and a condensing device 128 as well as preferably a catalytic device 134, the vapor plant 100 preferably enables the energy in the exhaust gas to be extensively recovered whereby the energy efficiency and/or the degree of efficiency of the vapor plant 100 can ultimately be increased.

In particular, the combination of the processes of supplying vapor to the combustion chamber 106 on the one hand and condensing constituents of the exhaust gas on the other makes it possible to operate the vapor plant 100 in an energy-efficient and efficiency-optimized manner whereby an after-treatment of the exhaust gases for reducing the nitrogen oxide content can preferably be dispensed with and/or is superfluous.

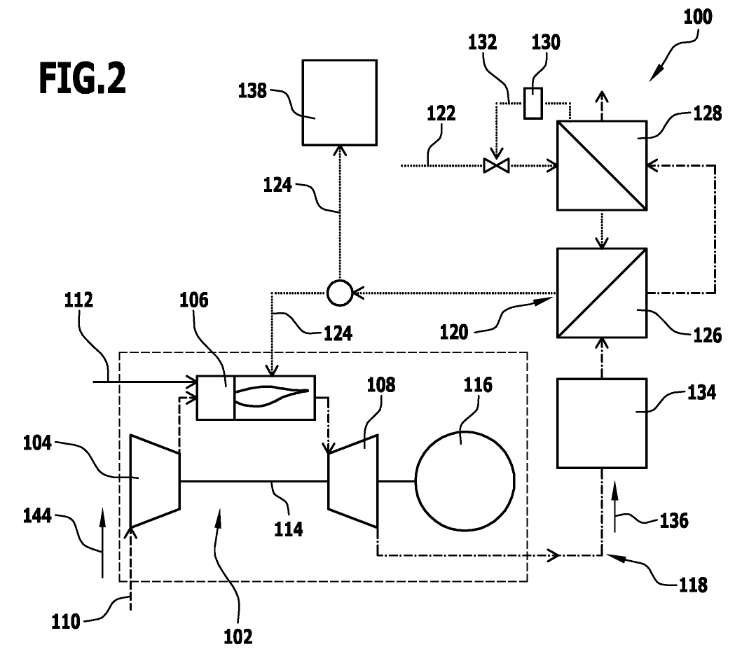

A second embodiment of a vapor plant 100 which is illustrated in FIG. 2 differs from the first embodiment illustrated in FIG. 1 substantially in that the catalytic device 134 is arranged upstream of the heat exchanger 126 for the purposes of coupling the exhaust gas system 118 to the vapor device 120.

Consequently, in the embodiment of the vapor plant 100 that is illustrated in FIG. 2, the exhaust gas flowing through the catalytic device 134 is hotter. This can be advantageous for the operation of the vapor plant 100 in dependence on the type of catalyst selected and/or the design.

In all other respects, the embodiment of the vapor plant 100 that is illustrated in FIG. 2 corresponds in regard to the construction and functioning thereof with the first embodiment illustrated in FIG. 1 and so to that extent, reference should be made to the previous description thereof.

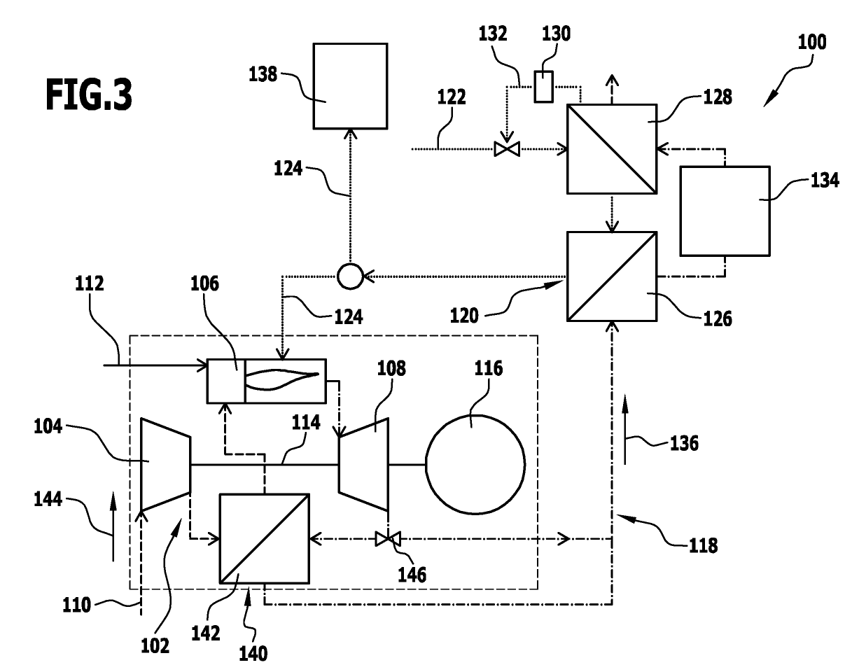

A third embodiment of a vapor plant 100 which is illustrated in FIG. 3 differs from the first embodiment illustrated in FIG. 1 substantially in that the gas turbine device 102 is provided with a recuperating device 140. The recuperating device 140 comprises a heat exchanger 142 by means of which the exhaust gas system 118 is thermally coupled to or couplable to the air supply inlet 110.

Hereby, the heat exchanger 142 is arranged downstream of the compressor 104 and/or upstream of the combustion chamber 106 taken with respect to a direction of flow 144 of the air flow in the air supply system 110.

The heat exchanger 142 is preferably arranged directly downstream of the turbine 108 taken with respect to the direction of flow 136 of the exhaust gas in the exhaust gas system 118.

The partial volume of the stream of exhaust gas that is supplied to the recuperating device 140 or that is fed past it and supplied directly to the heat exchanger 126 is preferably adjustable and in particular controllable and/or regulatable by means of a valve device 146 of the exhaust gas system 118.

In particular, the efficiency of the gas turbine device 102 can be optimized by the use of a recuperating device 140.

In all other respects, the embodiment of the vapor plant 100 that is illustrated in FIG. 3 corresponds in regard to the construction and functioning thereof with the first embodiment illustrated in FIG. 1 and so to that extent, reference should be made to the previous description thereof.

In a not illustrated further embodiment, any combination of features of the embodiments described above can be provided.

For example, in one embodiment of a vapor plant 100 which substantially corresponds to the embodiment illustrated in FIG. 3 and therefore comprises a recuperating device 140, the position of the catalytic device 134 could also be selected differently, for example, in correspondence with the second embodiment of the vapor plant 100 that is illustrated in FIG. 2.

1. A vapor plant, comprising:
a gas turbine device which comprises a compressor, a combustion chamber and a turbine;
a vapor device for the production of vapor and for supplying the vapor to the combustion chamber;
an exhaust gas system for the removal of exhaust gas produced in the combustion chamber;
a heat exchanger by means of which the exhaust gas system on the one hand and the vapor device on the other are thermally coupled or couplable to one another;
a condensing device by means of which the exhaust gas system on the one hand and the vapor device on the other are thermally coupled or couplable to one another.

2. The vapor plant in accordance with claim 1, wherein the vapor device comprises a liquid supply system and in that the exhaust gas system on the one hand and the liquid supply system of the vapor device on the other are thermally coupled or couplable to one another by means of the condensing device.

3. The vapor plant in accordance with claim 1, wherein the condensing device comprises a reservoir container for accommodating and/or storing condensate of the exhaust gas.

4. The vapor plant in accordance with claim 1, wherein the condensing device comprises a feedback device by means of which condensate of the exhaust gas is suppliable as a liquid to a liquid supply system of the vapor device.

5. The vapor plant in accordance with claim 1, wherein, taken with respect to a direction of flow of the exhaust gas in the exhaust gas system, the condensing device is arranged downstream of the heat exchanger by means of which the exhaust gas system on the one hand and the vapor device on the other are thermally coupled or couplable to one another.

6. The vapor plant in accordance with claim 1, wherein the vapor plant comprises a catalytic device for purifying the exhaust gas, wherein, taken with respect to a direction of flow of the exhaust gas in the exhaust gas system, the catalytic device is arranged upstream of the heat exchanger by means of which the exhaust gas system on the one hand and the vapor device on the other are thermally coupled or couplable to one another.

7. The vapor plant in accordance with claim 1, wherein the vapor plant comprises a catalytic device for purifying the exhaust gas, wherein, taken with respect to a direction of flow of the exhaust gas in the exhaust gas system, the catalytic device is arranged between the condensing device and the heat exchanger by means of which the exhaust gas system on the one hand and the vapor device on the other are thermally coupled or couplable to one another.

8. The vapor plant in accordance with claim 1, wherein the vapor plant comprises a recuperating device by means of which heat contained in the exhaust gas is transferable at least in part to a gas flow which is to be supplied to the combustion chamber.

9. A method of operating a vapor plant, in particular a vapor plant in accordance with claim 1, wherein the method comprises the following:
conversion of fuel and oxidizer in a combustion chamber of a gas turbine device of the vapor plant;
supplying vapor to the combustion chamber;
removing the exhaust gas produced in the combustion chamber from the combustion chamber;
transferring heat from the exhaust gas to a vapor device for the purposes of producing vapor by means of a heat exchanger;
condensing at least a portion of the vapor contained in the exhaust gas by means of a condensing device.

10. The method in accordance with claim 9, wherein the temperature of the exhaust gas after the transferal of heat from the exhaust gas to the vapor device by means of the heat exchanger lies above the dew point of water.

11. The method in accordance with claim 9, wherein the temperature of the exhaust gas is lowered below the dew point of water by means of the condensing device.

12. The method in accordance with claim 9, wherein impurities contained in the exhaust gas are chemically converted by means of a catalytic device.

13. The method in accordance with claim 9, wherein condensate of the exhaust gas that is produced by means of the condensing device is at least partly re-vaporized and supplied to the combustion chamber.

14. The method in accordance with claim 9, wherein the supply of vapor to the combustion chamber is controlled and/or regulated in such a way that a water content of the exhaust gas amounts to at least approximately 6 Vol %, preferably to at least approximately 8 Vol %, for example, to at least approximately 10 Vol %.

15. The method in accordance with claim 9, wherein vapor produced by means of a vapor device of the vapor plant is partly supplied to the combustion chamber and partly to a vapor turbine of the vapor plant.
